(19) United States
(12) Patent Application Publication
(10) Pub. No.: US 2007/0018822 A1
(43) Pub. Date: Jan. 25, 2007

(54) DCR TV system for forwarding EAS information and method thereof

(75) Inventors: Young-jin Lee, Incheon (KR); Dong-won Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/413,182

(22) Filed: Apr. 28, 2006

(30) Foreign Application Priority Data
Jul. 21, 2005 (KR) 2005-0066239

(51) Int. Cl. G08B 13/14

(52) U.S. Cl. 340/572.1

(57) ABSTRACT

A digital TV system for forwarding EAS information and a method thereof are provided. The digital TV system forwards the EAS information to an external device including a mobile phone. Accordingly, even if a user does not watch the TV or does something different from watching the TV, the user can easily obtain the EAS information through his/her own mobile phone and promptly cope with an emergency situation.

### CROSS REFERENCE TO RELATED APPLICATION

This application claims the benefit under 35 U.S.C. § 119(a) of a Korean patent application No. 2005-66239, filed on Jul. 21, 2005, in the Korean Intellectual Property Office, the entire contents of which are hereby incorporated by reference.

### BACKGROUND OF THE INVENTION

1. Field of the Invention

The present invention relates to a digital cable ready (DCR) TV system. More particularly, the present invention relates to a digital TV system for forwarding emergency alert system (EAS) information to a mobile phone.

2. Description of the Related Art

Compared to the analog broadcasting, the digital broadcasting provides a user with a better service in view of more vivid image quality and CD-quality sound. The digital broadcasting provides an electronic program guide (EPG) such that a novice user can easily manipulate a digital TV. The EPG provides information about program identifier (PID), a time schedule, a program grade, and an aspect ratio to allow a user to easily use the digital TV.

Currently, in order to maximize user's convenience, the digital broadcasting provides emergency alert system information (hereinafter referred to as EAS information) to warn users about emergency situations and advise them to be shunted.

If a digital cable ready digital (DCR) TV is equipped with a point of deployment (POD), the EAS information is received through the out-of-band, and otherwise, the EAS information is received through the in-band.

The received EAS information calls a viewer's attention to an emergency situation.

FIG. 1 is a flowchart illustrating a conventional method for receiving EAS information, which displays local EAS information in relation to only the area where a user lives.

Information about the residence of a user has been already input to the DCR TV by the user. After that, EAS information is received from an external source at step S10.

More specifically, a user inputs information about the user's residence in a method of using a zone improvement program (ZIP) code, using a category, or directly inputting through a keypad.

Next, it is determined whether EAS information received through a different band exists at step S20.

Since a regular cable digital TV comprises the POD, it receives the EAS information through the out-of-band. However, the EAS information may be received through the in-band.

Therefore, it is determined whether the EAS information is twice received through both the out-of-band and the in-band.

If there is the EAS information received through a different band at step S30, the EAS information received through the out-of-band is selected and processed at step S40.

That is, if the EAS information is twice received through the out-of-band and the in-band, the EAS information received through the out-of-band has a priority.

Next, it is determined whether the EAS information received through the out-of-band is about the area where the user lives at step S50.

More specifically, it is determined whether the EAS information received through the out-of-band corresponds to the residence of the user that has been already input to the cable digital TV by the user. If the EAS information corresponds to the residence of the viewer at step S60, the EAS information is displayed and provided to the user who is watching the TV at step S70.

If the EAS information received through the out-of-band does not correspond to the residence of the viewer at step S60, the EAS information is not provided to the viewer.

If the EAS information is not received twice at step S30, the EAS information is processed regardless of which EAS information has a priority.

As described above, the conventional method for receiving the EAS information is advantageous in that it selects local EAS information corresponding to the area where a user lives. However, the conventional method does not provide the EAS information to a user who does a different work when the EAS information is broadcasted or a viewer who lives in different area. That is, if a user watches a TV, the user can perceive the EAS information, but if a user does a different work when the EAS information is broadcasted or a user lives in different area, the user is unaware of an emergency situation.

### SUMMARY OF THE INVENTION

Exemplary embodiments of the present invention are to address the above problem and other problems. Accordingly, an aspect of the present invention is to provide a digital TV system capable of forwarding emergency alert system (EAS) information to a mobile phone and thereby informing not only a user who is watching a TV but also a user who is not watching a TV about an emergency situation, and a method thereof.

The above exemplary aspect can be achieved by providing a display device comprising a receiver for receiving EAS information, and a controller for controlling the received EAS information to be forwarded to an external communication device as message.

According to an exemplary embodiment of the present invention, the display device further comprises a memory for storing a receiver list setting table to forward the EAS information to the external communication device, wherein the controller controls the EAS information to be forwarded to a receiver that is set in the receiver list setting table.

Preferably, but not necessarily, the controller forward the EAS information to a mobile phone of a receiver as text message, and the receiver list setting table comprises a receiver name and a receiver telephone number to forward the EAS information.

Preferably, but not necessarily, the receiver list setting table further comprises a check column for individually determining whether to forward the EAS information, and the controller for forwarding the EAS information to a mobile phone of a receiver who is determined to receive the EAS information in the receiver list setting table as text message.

According to an exemplary embodiment of the present invention, the receiver comprises a point of deployment (POD) cable card.

The above exemplary aspect may be also achieved by providing a method for forwarding EAS information of a display device which forwards EAS information to an external communication device. The method comprises receiving the EAS information from an external source, and forwarding the EAS information to the external communication device as message.

According to an exemplary embodiment of the present invention, the method further comprises setting at least one of receiver numbers and forwarding the EAS information to the external communication device of the set receiver as message.

According to an exemplary embodiment of the present invention, the EAS information forwarding operation forwards the EAS information to a mobile phone of a receiver as text messages, and the receiver number setting operation sets a name and a telephone number of a receiver who is to receive the EAS information.

According to an exemplary embodiment of the present invention, the receiver number setting operation further comprises determining whether to forward the EAS information to the receiver, individually, and when the EAS information is received, the display device forwards the EAS information to a mobile phone of a receiver who is determined to receive the EAS information in the receiver setting operation as text message.

### BRIEF DESCRIPTION OF THE DRAWINGS

This and/or other aspects of exemplary embodiments of the present invention will become apparent and more readily appreciated from the following description of the embodiments, taken in conjunction with the accompanying drawings of which:

FIG. 1 is a flowchart illustrating a conventional method for receiving emergency alert system (EAS) information;

FIG. 2 is a block diagram illustrating a system that forwards EAS information to a mobile phone by using a display device according to an exemplary embodiment of the present invention;

FIG. 3 is a flowchart illustrating a method for forwarding EAS information to a mobile phone according to an exemplary embodiment of the present invention; and

FIG. 4 is a setting table illustrating a receiver list.

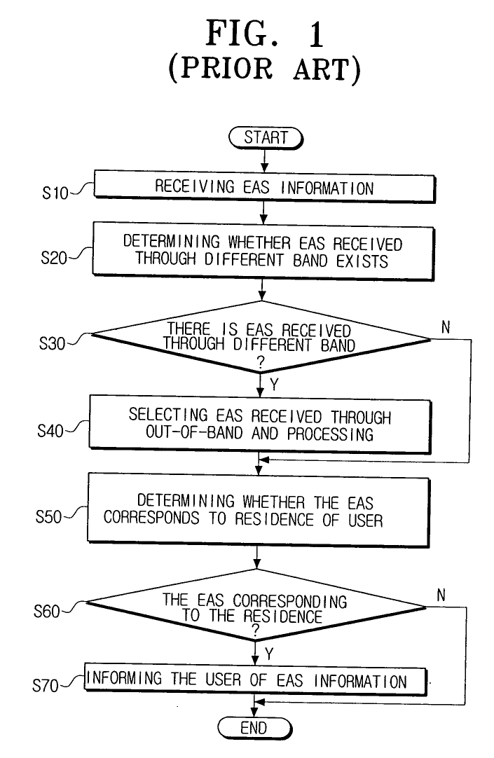

Throughout the drawings, like reference numerals will be understood to refer to like parts, components and structures

### DETAILED DESCRIPTION OF EXEMPLARY EMBODIMENTS

Hereinafter, exemplary embodiment of the present invention will now be described in greater detail with reference to the accompanying drawings.

FIG. 2 is a block diagram illustrating a system that forwards emergency alert system (EAS) information to a mobile phone by using a display device according to an exemplary embodiment of the present invention. The system 100 comprises a multiple system operator (MSO) system (110, a display device 120 comprising a digital cable ready (DCR) TV system, which is connected to the MSO system 110 via cable and supports a cable card, an Internet 130, a short message service (SMS) server 140, and a mobile phone 150.

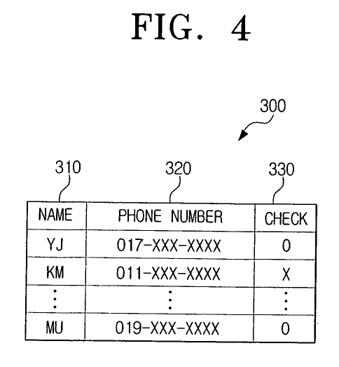

The MSO system 110 transmits EAS information to the display device 120 through a cable. The display device 120 comprises a point of deployment (POD) cable card 122 to receive EAS data, a memory 126 to store a receiver list setting table 300 (see FIG. 4) to forward the received EAS data, and a controller 124 that controls an on-screen display (OSD) generator 128 to display the receiver list setting table stored in the memory 126 and thus to allow a user to set a telephone number to forward the EAS information, and that, when the EAS information is received, controls a SMS message to be forwarded to the telephone number set in the memory 126.

The display device 120 communicates with SMS server 140 according to the interface standards “DOCSIS” for a cable modem that processes data input/output among a cable TV company, a personal computer, and a TV.

FIG. 4 is an example of a setting table illustrating a receiver list. The receiver list setting table 300 comprises a name column 310 indicating a name of a receiver who is to receive the EAS information and a phone number column 320. The receiver list setting table 300 also comprises a check column 330 to determine whether to forward the EAS information to a receiver if there are a plurality of receivers.

When the controller 124 requests the SMS server 140 to forward the EAS information to a corresponding telephone number according to the receiver list setting table 300, the SMS server 140 operates to forward the EAS information to the corresponding telephone number.

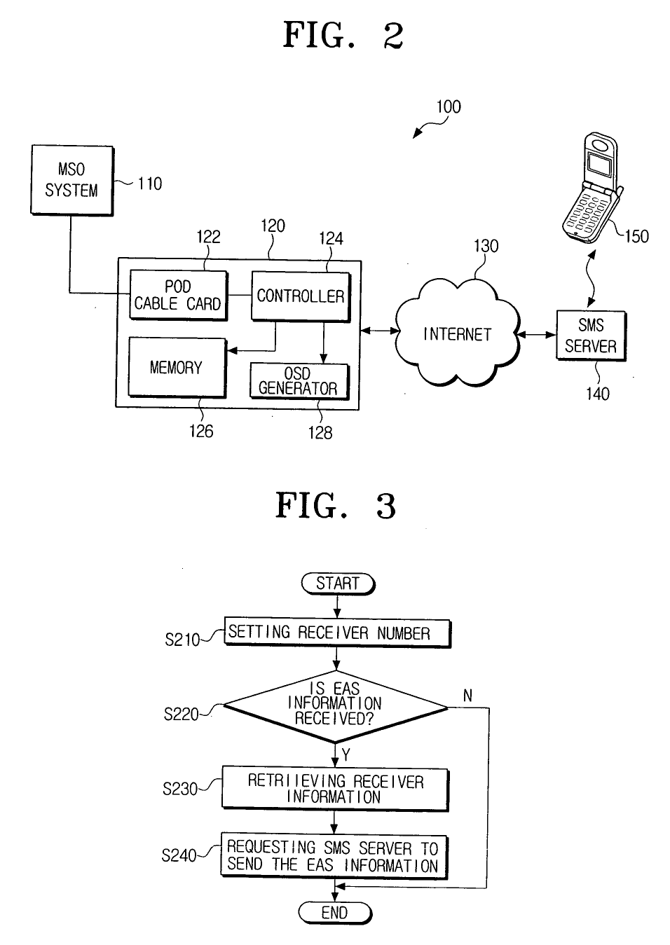

A method for forwarding the EAS information of the display device will be described with reference to FIG. 3.

First, a user sets a receiver telephone number in the display device 120 to forward the EAS information received from the MSO system 110 to the SMS server 140 at step S210.

More specifically, if a receiver setting mode is selected through a key input part (not shown) of the display device 120, the controller 124 retrieves the receiver list setting table 300 (see FIG. 4) from the memory 126 and displays the same in order for a user to set or edit.

If the receiver setting operation is completed at step S210, the controller 124 determines whether the EAS information is received through the POD cable card 122 at step S220. If the EAS information is received, the controller 124 retrieves a receiver telephone number from the telephone number column 320 of the receiver list setting table 300 at step S230, and requests the SMS server 140 to forward the EAS information to the retrieved telephone number at step S240.

At step S230, the receiver information, such as a telephone number, is confirmed based on the check column 330 of the receiver list setting table 300.

According to an exemplary embodiment of the present invention as described above, since the EAS information is directly provided to the user based on the receiver list setting table that is set in the DTV in advance, it is possible to protect the user from a dangerous situation and it is possible for the user to cope with an emergency situation promptly.

According to an exemplary embodiment of the digital television capable of forwarding the EAS information to the mobile phone and the method thereof, a user can properly cope with an emergency situation anywhere by simply setting the user's telephone number to the DTV or set-top box. That is, even if a user does not watch the TV or does something different from watching the TV, the user can easily obtain the EAS information through his/her own mobile phone and promptly cope with an emergency situation.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display device comprising:
a receiver for receiving emergency alert system (EAS) information; and
a controller for forwarding the received EAS information to an external communication device as message.

2. The display device as claimed in claim 1, further comprising a memory for storing a receiver list setting table to forward the EAS information to the external communication device, wherein the controller controls the forwarding of the EAS information to a receiver that is set in the receiver list setting table.

3. The display device as claimed in claim 2, wherein the controller forwards the EAS information to a mobile phone of a receiver as text message.

4. The display device as claimed in claim 2, wherein the receiver list setting table comprises at least one of a receiver name and a receiver telephone number to forward the EAS information.

5. The display device as claimed in claim 4, wherein the receiver list setting table further comprises a check column for individually determining whether to forward the EAS information, and the controller forwards the EAS information to a mobile phone of a receiver who is determined to receive the EAS information in the receiver list setting table as text message.

6. The display device as claimed in claim 1, wherein the receiver comprises a point of deployment (POD) cable card.

7. A method for forwarding EAS information of a display device which forwards EAS information to an external communication device, the method comprising:
receiving EAS information from an external source; and
forwarding the EAS information to the external communication device as message.

8. The method as claimed in claim 7, further comprising setting at least one receiver number and forwarding the EAS information to the external communication device of the at least one set receiver number as message.

9. The method as claimed in claim 8, wherein the forwarding of the EAS information comprises forwarding the EAS information to a mobile phone of a receiver as text messages.

10. The method as claimed in claim 8, wherein the setting of the at least one receiver number comprises setting at least one of a name and a telephone number of a receiver receiving the EAS information.

11. The method as claimed in claim 10, wherein the setting of the at least one receiver number further comprises determining whether to forward the EAS information to the receiver, individually, and when the EAS information is received, forwards the EAS information to a mobile phone of a receiver determined to receive the EAS information in the receiver setting operation as text message.

12. The method as claimed in claim 10, wherein the forwarding of the EAS information to the mobile phone of the receiver comprises forwarding by the display device.
